(19) United States
(12) Patent Application Publication
(10) Pub. No.: US 2002/0187702 A1
(43) Pub. Date: Dec. 12, 2002

(54) Composite thermoplastic-thermoset resin material

(76) Inventors: Arthur K. Delusky, Detroit, MI (US); Thomas M. Ellison, Fort Mill, SC (US); Stephen P. McCarthy, Tyngsboro, MA (US)

Correspondence Address: Robert H. Bachman, BACHMAN & LaPOINTE, P.C., Suite 1201, 900 Chapel Street, New Haven, CT, 06510-2802, US

(21) Appl. No.: 09/876,500

(22) Filed: Jun. 7, 2001

(51) Int. Cl. B32B 17/02; D04H 1/00

(52) U.S. Cl. 442/394; 442/180

(57) ABSTRACT

Composite structure and process for forming same, wherein the composite structure has an outer film layer, a thermoplastic layer bonded to the outer film layer, and a thermoset layer bonded to the thermoplastic layer. The thermoset layer is bonded to the thermoplastic layer by an adhesion site that serves to bond the thermoset layer to the thermoplastic layer.

### BACKGROUND OF THE INVENTION

Thermoplastic parts are desirable in many applications, such as, for example, in automotive applications, because of their desirable attributes, as ease of molding, lightweight and good surface finish characteristics. However, the lower cost thermoplastics, such as polypropylene (PP), thermoplastic olefins (TPO) and acrylonitrile-butadiene-styrene (ABS) are deficient in structural strength and stiffness for certain applications.

On the other hand, thermoset polyesters are used extensively for applications that require strength and rigidity. These are often used with glass fibers and/or fillers therein; however, the glass fibers and/or fillers tend to create a rough, porous surface that requires extensive surface preparation for painting. In addition, the amount of resin used combined with the glass and fillers tend to make the resultant parts heavier than the corresponding thermoplastic parts.

U.S. Pat. No. 3,679,510 describes a method for molding a thermoplastic ABS sheet laminated to a polyvinyl fluoride (PVF) film with a thermoset polyester resin. However, the '510 patent itself recognizes the disadvantage that the raising of glass fibers near the surface of the material is unsightly and greatly detracts from the appearance of the final product. The product described in the '510 patent has a woodgrain-printed surface which is much less demanding with respect to such a disadvantage.

It is highly desirable and it is an objective of the present invention to provide a combination of the aforesaid two technologies wherein a thermoplastic first layer effectively maintains a good surface finish and reduces overall part weight while providing a relatively thin component as compared to the thickness of a part made substantially solely with a thermoset material. The thermoset second layer would desirably provide good strength and rigidity.

A further objective of the present invention is to provide a glass-reinforced thermoset layer without the disadvantageous surface appearance thereof.

A still further objective of the present invention is to provide such a composite material which has an outer paint film on the thermoplastic surface so that post mold painting may be eliminated.

Further objects and advantages of the present invention will appear hereinbelow.

### SUMMARY OF THE INVENTION

In accordance with the present invention, the foregoing objects and advantages may be readily obtained and an improved composite material simply, conveniently and inexpensively obtained.

The composite material of the present invention comprises: an outer film layer, desirably a colored or paint film; a thermoplastic layer bonded to the outer film layer; and a thermoset layer bonded to the thermoplastic layer; wherein the thermoset layer is bonded to the thermoplastic layer by an adhesion site that serves to bond the thermoplastic layer to the thermoset layer. The adhesion site may be activated by a component of the thermoset resin that acts on a component of the thermoplastic resin, as by the solvent action of a component in the unreacted thermoset resin, or alternatively by mechanical penetration of a thin, porous layer by the two resins.

In one embodiment, the component in the unreacted thermoset resin is a monomer or low molecular weight polymer of styrene and the component in the thermoplastic is styrene or a polystyrene segment in a copolymer or resin blend. For example, a thermoplastic based on ABS is bonded to a styrene containing polyester thermoset resin. Alternatively, the thermoplastic may be an olefin such as polypropylene which contains co-reacted styrene or acrylic segments. Likewise, other thermoplastics containing polymer segments that are subject to adhesive activation by styrene, such as polycarbonate, may be used.

In another embodiment the reactive component in the thermoset resin is an unreacted or partially reacted isocyanate, polyol, or epoxy compound and the component in the thermoplastic is a monomer unit or polymer segment that will be solvent activated by the reactive component in the thermoset resin. The monomer unit or polymer segment in the thermoplastic may be styrene, acrylic, polycarbonate, polyester or other monomer unit that will be solvent activated by the reactive component thermoset resin.

In yet another embodiment of the present invention, the adhesion site is a porous veil, such as a thin, non-woven porous fabric with pores or passageways therein, which is between the thermoplastic and thermoset layers. Both the thermoplastic and thermoset layers impregnate and bond to the porous veil.

The composite material of the present invention is desirably a compression molded article having a desired shape and configuration.

The process of the present invention comprises: forming a composite material by sequentially depositing a thermoplastic layer onto an outer film layer, followed by depositing a thermoset layer onto the thermoplastic layer, wherein the thermoset layer is bonded to the thermoplastic layer by an adhesion site that serves to bond the thermoplastic layer to the thermoset layer.

Further features of the present invention will appear hereinbelow.

### BRIEF DESCRIPTION OF THE DRAWINGS

The present invention will be more readily understood from a consideration of the accompanying illustrative drawings, wherein:

FIG. 1 is a partly schematic view of an apparatus and process in an early stage of the preparation of the articles of the present invention;

FIGS. 2 and 3 are partial views showing variations in the apparatus and process in early stages of the preparation of the articles of the present invention;

FIG. 4 is a partly schematic view showing a further embodiment in a subsequent stage of preparation of the articles of the present invention;

FIG. 5 is a partial sectional view of a composite of the present invention;

FIG. 6 is a partial sectional view of the composite of FIG. 4 in the formed, compression molded condition; and

FIG. 7 is a partial sectional view of a further embodiment of a composite of the present invention.

### DETAILED DESCRIPTION OF PREFERRED EMBODIMENTS

The thermoplastic layer-outer film component may be formed by the procedure of U.S. Pat. No. 6,132,669.

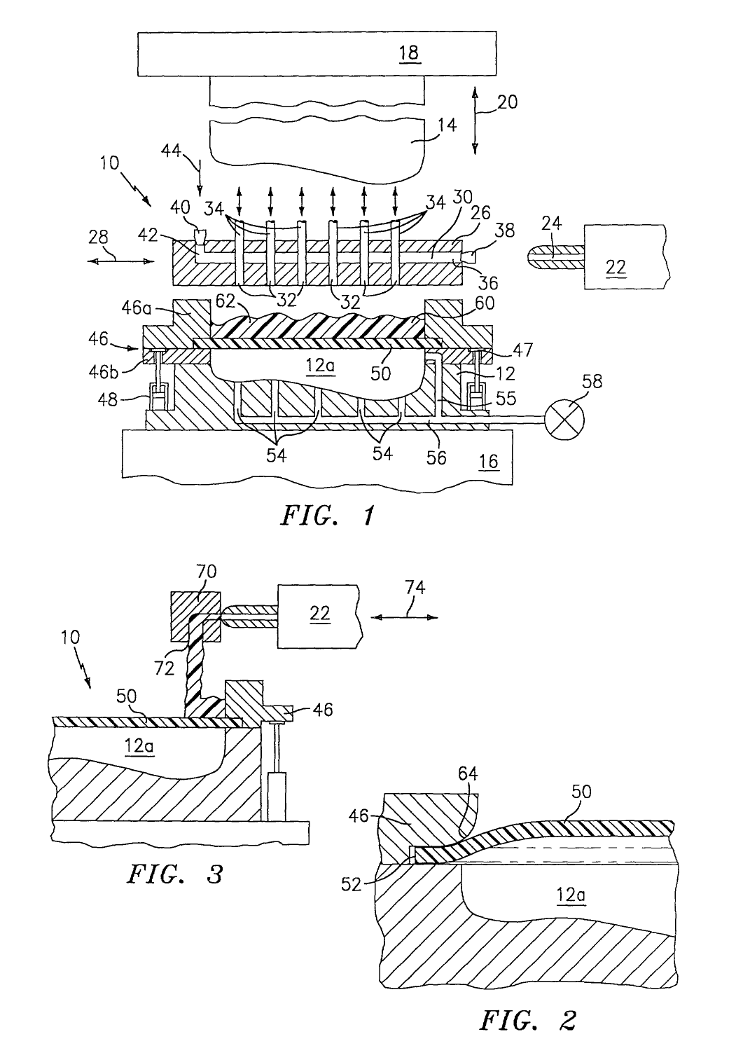

Thus, referring to FIGS. 1-3, a mold 10 consisting of cavity half 12 having a mold cavity 12a therein and core half 14 is mounted on respective platens 16 and 18. Mold cavity 12a has a shape of the desired final molded article. At least one of cavity half and core half is reciprocable in the direction of the arrow 20 from an open to a closed position and from a closed to open position via motive means (not shown). An extruder/injection unit 22 having a nozzle 24 is arranged adjacent mold 10 to coact and couple with a hot plastic delivery means, as plate 26. Plate 26 is relatively reciprocable in the direction of the horizontal arrow 28 from a position adjacent mold cavity 12a to a position spaced from mold cavity 12a and is supplied with hot, flowable plastic by extruder 22 and nozzle 24. Depending on the nature of plate 26, the extruder may be stationary or reciprocable with plate 26. Naturally, other variations in the hot plastic delivery system may be used. For example, the extruder/injection system and hot plastic delivery means may be stationary externally to the press and the mold traversed reciprocably relative to the extruder/injection system. Other variations may be readily contemplated.

Plate 26 in FIG. 1 is a hot runner having an elongated channel 30 which communicates with a multiplicity of openings 32 positioned over mold cavity 12a. Each opening is closeable by known means, as by valve means 34. The openings 32 receive hot plastic under pressure from extruder 22 through extruder nozzle 24 and hot runner feed channel 30. While the extruder 22 and hot runner delivery plate 26 are coupled, plastic is caused to flow from nozzle 24 into channel 30. For the delivery plate to operate when the extruder is detached, a free end 36 of channel 30 contains a check valve 38 (shown schematically), and pressurized piston means 40 are added to engage the opposed end 42 of channel 30 to operate by conventional means, for example, a hydraulic cylinder (not shown) to apply force to hot runner channel 30 in the direction of the horizontal arrow 44.

Alternatively, one could selectively close valve means 34 and apply pressure through piston means 40, thereby obtaining a thicker coating in desired locations. Alternatively, one could use shooting pots or plastic reservoirs, for example, connected to each individual valve means, thereby obtaining additional resin thickness where desired.

In one method of operation, the extruder 22 is left in place spaced from mold 10 and the plate 26 alone is moved into position over mold cavity 12a as shown in FIG. 1, after having been charged with hot plastic by extruder 22. To prevent drooling, check valve 38 is closed. In addition, piston means 40 may be retracted in engagement with channel end 42, thereby creating suction in channel end 42 to better retain the hot plastic therein.

A hold down and spacer frame 46 is aligned with cavity half 12, engageable therewith and detachable therefrom and coupled with means to move same (not shown) towards and away from cavity half 12 independently of the reciprocal movement of core half 14. Thus, a pair of lift cylinders 48 may be mounted on either platens 16 or 18 with mounting on platen 16 being shown in FIG. 1.

Thus, plate 26 is filled with hot plastic by extruder 22. If the two are coupled, they are moved so as to place the hot runner into alignment with cavity half 12. Before so placing the hot runner, spacer frame 46 is lifted away from cavity half 12 far enough to permit a precut film or blank 50 to be placed over the rim 52 (see FIG. 2) of the mold cavity 12a of cavity half 12 by any desired means, as for example, shown in the '457 patent. With the blank or outer film layer 50 in place, frame 46 is moved towards cavity half 12 to clamp outer film layer 50 over the mold cavity 12a as shown in FIG. 2, thereby rendering said cavity capable of retaining elevated fluid pressure. Optionally, the film may be offset from the cavity and supported by air jets. Alternatively, spacer frame 46 may include an upper half 46a and a lower half 46b with a space 47 therebetween as shown in FIG. 1. This clamp may be a slip clamp to permit release of the film into mold cavity 12a during forming and thereby minimize edge scrap and reduce the amount of film thinning that may occur. If desired, scrap trim may be minimized by folding over excess film and heat sealing the excess film to inside edge portions of the molded article, as by ironing.

Fluid pressure may then be applied to mold cavity 12a under film 50, as through channels 54 connected through a joint manifold 56 with pressure control means 58. The fluid usually used is air, but may also be an inert gas if the material of film 50 so requires. Alternatively, fluid pressure may be applied through channel 55 in cavity half 12 directly beneath film blank or film 50 in order to properly hold the film in place. Preferably, a plurality of locations, or a continuous channel, are provided around the circumference of the film directly beneath the film. Also, these may be valved separately from channels 54 or used instead of channels 54.

Nozzle valve means 34 are then withdrawn to allow hot plastic for the thermoplastic layer to flow freely from hot runner plate 26 through nozzle openings 32 onto film 50 in the space between the hot runner plate 26 and film 50 and within frame 46. The space within frame 46 is not filled under substantial pressure, such as usual in injection molding. Rather, only an accurately metered amount 60 of hot thermoplastic material is deposited upon film 50 from hot runner plate 26, namely that which corresponds substantially to the molding cavity to be formed in mold cavity 12a by cavity half 10 and core half 14 in the closed condition.

It is important to note that in consequence of introducing the hot thermoplastic material into the space within frame 46, no more pressure is applied underneath the film via fluid channels 54 and 55 than that sufficient to support the metered amount 60 of plastic being so deposited. Desirably, the air pressure is variable depending on product requirements. Indeed, vacuum may be used during forming. As schematically indicated in FIG. 1, that metered amount 60 will comprise a thermoplastic layer that will conform to the flat surface of the film on one side, while its opposite surface will have an uneven surface 62 as clearly shown in FIG. 1, showing traces of the viscous flow pattern that will have emerged from nozzles 32. Naturally, the nozzles are spaced closely enough to permit the emerging plastic to form a continuous, homogeneous layer. Alternatively, one thermoplastic polymer could be deposited in a designed pattern, and a second or a plurality of second polymers deposited in a designed pattern. This could be done with one or more extruders feeding for example separate channels to deposit a predesigned pattern of multiple resins. As a further alternative, one could sequentially feed thermoplastic polymers of different characteristics to provide designed properties in the finished product.

Each of nozzles 32 may be independently temperature controlled, if desired, and hence capable of depositing the plastic in a pattern of predetermined temperature distribution.

Before releasing the hot plastic into the space above film 50, the mold cavity 12a is pressurized as described above, as by air pressure entering through channels 54. Since the finished product is usually thin, while having a large surface area, the weight of metered plastic 60 is relatively low and the average static pressure it exerts upon the film or blank 50 is low as well. Hence, relatively low pressure in the mold cavity will suffice to keep the film 50 from sagging under the weight of the metered plastic, even when film 50 is heated by contact with the metered plastic. For example, a metered amount of plastic measuring 2′×4′×0.5″, made of plastic weighing 0.05 pounds per cubic inch, will exert a pressure of 0.025 psi over the said area. This amounts to very slight over pressure, with the result that said film will not bulge (balloon) upward excessively when pressure is first applied under it. In exceptional instances, the layer of hot plastic being applied over the film may be of much greater depth. Even then, the above indicated pressure would not cause excessive bulging. Forming of a crease-like line at the edge of spacer frame 46, may be prevented as shown by a curved clamping surface 64 thereof in FIG. 2 with slight upward bulging of film 50 shown caused by pressurization of mold cavity 12a. Indeed, upward bulging may be desirable in some instances, as for feed draw parts.

In one embodiment of the present invention, after deposition of the plastic layer 60 on film 50, plate 26 is moved from between cavity half 12 and core half 14 and mold 10 is closed, as by moving core half 14 into mold cavity 12a. This results in forming the film and deposited plastic into a composite laminate in the shape of the closed mold cavity in an expeditious and convenient manner. Subsequent steps to form the final composite of the present invention will be described below.

The blank or film is preferably plastic, and any desired plastic material which will form under the specified molding conditions may be used for the blank material which desirably bonds directly to the thermoplastic material, although an adhesive may be used to facilitate bonding. For example, polyolefins, polyvinyl chloride, polystyrene, polycarbonates, etc. Any thermoplastic material may be used for the molten material, such as for example, polyolefins as polypropylene or polyethylene or copolymers thereof, acrylonitrile-butadiene-styrene (ABS), styrene modified polyolefins, as styrene modified polyethylene or polypropylene or copolymers thereof, acrylic modified polypropylene, polycarbonate, polycarbonate modified polyester, acrylonitrile-styrene-acrylic (ASA), etc. The blank or film may be cut or stamped from a web and a supply of blanks having the size and shape to fit over mold cavity 12a maintained adjacent mold 10 for transfer to the mold as described above. The film is desirably colored and the depth of color on the blank may naturally be varied depending on needs. One should naturally consider the thinning of the blank or film during processing and adjust the color depth to the amount of deformation any given portion of the blank or film is to undergo. Thus, for example, thicker paint coatings may be applied to selective blank or film locations that are to obtain greater deformation during processing in order to obtain uniformity of color in the final molded product. The blank or film may, for example, be intaglio-printed. The blank may be applied to the mold with robot means or removably adhered to a carrier film strip. A carrier film strip may be provided with means to register the position of the film relative to the mold half onto which the film is to be placed, e.g., edge perforations. The carrier, with the film attached, may then be supplied from a roll. Once the film and mold are juxtaposed, suction is applied to the edge of the film by the mold, as through channels, sufficient to separate the film from the carrier strip. Naturally, other transfer means may readily be used.

FIG. 3 shows an alternate method for applying the hot plastic. Instead of plate 26 being a hot runner as shown in FIG. 1, the extruder 22 is coupled with a so-called coat hanger die 70, serving as a hot plastic delivery plate, i.e., die with a slit opening 72 for the plastic as normally used for the extrusion of wide sheets. The extruder 22 and die 70 are reciprocable in the direction of arrow 74 towards and away from mold 10. In operation, the blank 50 having been placed over the mold cavity 12a and clamped down as by spacer frame 46, as in FIGS. 1-2, the extruder 22 and die 70 are traversed over blank 50, and the desired layer of hot plastic is deposited thereover. The thickness of the plastic layer is given by the speed of traverse, the output of the extruder and the dimensions of the die, all controlled in a conventional manner. At the end of the traverse, the extruder is shut off and returned to its starting position. One may provide an extruder with width and/or thickness control to control the thickness and/or width of the plastic layer. The speed of traverse and/or the output of the extruder could be variable. The positioning of the extruder in the X, Y and Z planes could be variable to vary the dimensions and/or configuration of the plastic layer.

A significant feature of the present invention is the uniformity of heating of the film or blank without having to resort to external means, and the assurance that the forming operation is carried out simultaneously, film or blank and the backing layer, followed by the application of high enough molding pressures to provide mold conformance of both. The finish of the film is thereby preserved and optically detectable imperfections are reduced. Also, this procedure requires much lower clamping pressure than conventional procedures.

In a preferred embodiment, the thermoset material may be deposited directly over the thermoplastic material either directly through the core or by a hot runner or by laying a preformed sheet over the molten thermoplastic material. A preferred thermoplastic material contains styrene, as ABS or styrene modified polypropylene, and a preferred thermoset material contains styrene, as styrene modified polyester. Thus, the thermoset layer will bond directly to the thermoplastic layer chemically by the action of styrene in both components as an adhesion site, and the resultant components compression molded.

Alternatively, the paint film and thermoplastic resin layer may be compression molded by closing the core. The mold is opened and the thermoset layer placed over the molded composite, and the composite material of the present invention finally formed.

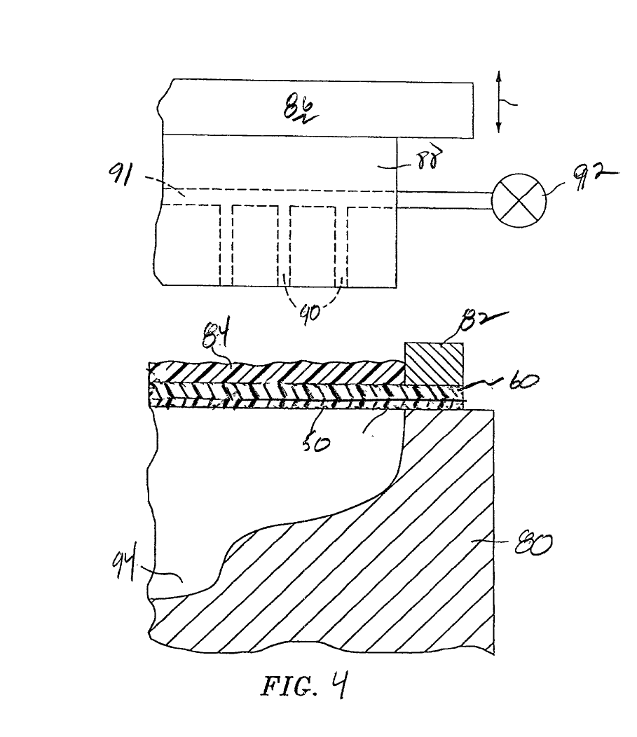

FIG. 4 shows an alternate embodiment in a subsequent stage of operation, wherein the composite of outer film layer 50 and thermoplastic layer 60 is held over mold 80 by frame 82 while thermoset material 84 is sequentially deposited on the thermoplastic layer. Platen 86 is shown with a forming mandrel 88, which is desirably a solid metal mandrel but which may also be for example an elastomeric mandrel, and which may contain air slots 90 which intersect a manifold slot 91 connected to a source of fluid pressure and pressure control means 92 connected thereto. Mold 80 includes mold cavity 94 which forms the shape of the desired molded article. Naturally, any desired mold cavity shape may be used.

In operation, the mandrel 88 enters the clamping frame 82 to form the desired article. Pressure air may be applied to slots 90 if used expanding the slots into passages. The mandrel conforms the laminate to the surface of the mold cavity resulting in forming the desired article with a sequential deposition process, i e. first the thermoplastic material is deposited on the outer film, followed by sequentially depositing the thermoset resin. Any desired intermediate or subsequent layers would desirably be sequentially deposited.

The thermoplastic layer and the thermoset layer desirably have a thickness from about 0.035 inch to 0.120 inch in the final product, preferably about 0.060 inch.

In the absence of styrene as an adhesion site, a mechanical bond may be achieved by placing a porous veil or mat between the thermoplastic and thermoset layers, such as a thin, non-woven fabric, and then molding the final part. Each polymer layer then flows into the open spaces in the veil from the respective sides of each of the polymers to create a bond between the layers.

The desirable surface finish is created by the outer paint film, which may be a composite film. For example, a polyvinyl fluoride (PVF)-ABS laminate may be used. This may bond directly to the deposited thermoplastic or an intermediate adhesive used. Naturally, other convenient outer films may be readily used, such as an acrylic or acrylic/PVDF base coat-clear coat film laminated to ABS or an olefin sheet. The outer paint coat films or paint film laminates are desirably less than about 0.030 inch thick. The thermoset layer desirably includes glass fibers or strengthening additives and the combined thicknesses of the thermoplastic layer and outer film layer combine to mask read through of the glass fibers and/or additives in the thermoset layer to provide a highly desirable outer film finish. If a non-woven fiber veil or other porous veil is used between the thermoset and thermoplastic layers, this will serve to further isolate the fibers and/or additives in the thermoset layer from the surface.

A typical thermoset resin for the present invention is a mixture of unsaturated polyester, styrene, peroxide catalyst, inorganic fillers, glass fibers or fiberglass and thickeners. The polyester resin may be made by an esterification reaction between di- or polycarboxylic acids with polyols. The thermoset resin may be referred to as a sheet molding compound (SMC) when supplied as a thin sheet of material. It may also be supplied as bulk dough-like material which may be referred to as bulk molding compound (BMC).

After deposition of the thermoplastic layer as shown in FIGS. 1-3, a typical procedure for forming the composite of the present invention is to place a layer of SMC over the thermoplastic deposit. If the paint film is suspended over the mold cavity, the mold may be then closed to mold the final product. If the paint film is suspended over a frame and the frame spaced from the mold cavity, the frame may then be transferred to the mold cavity and the mold closed to mold the final product. Heat from the thermoplastic deposit, in addition to softening the paint film for forming, will initiate the addition reaction of the styrene-polyester resin with the peroxide catalyst. Auxiliary heat to complete the reaction may be provided by heating the mold core. The cure range for polyester resins generally requires a temperature in the range of 200-350° F. to initiate and complete the cure. On heating, the viscosity of the thermoset resin drops due to the heat and the resin starts to rapidly thicken due to the cross-linking reaction of the styrene and polyester resin. This creates a timing window in which the mold must be closed before the polyester cures to the point of not being formable. The closure time generally ranges from between about 5 to 30 seconds depending on the particular formulation of the polyester, the temperature of the thermoplastic deposit and/or the mold core temperature.

A further alternative is to place the paint film or the like in a frame or over the cavity as in FIGS. 1-3, supply thermoplastic resin over the paint film and mold the film-resin composite by closing the first core. After a short cool time, the mold is opened and the cavity containing the molded film-resin composite is shuttled to a second press station having a second core slightly undersized relative to the first core. An SMC or BMC charge containing fibers is then placed over the molded shell or intermediate molded product while it is still in the mold cavity. The heated second core is then closed to mold and cure the thermoset resin and form the final molded product. The partial cooling of the thermoplastic molded shell aids in insuring the masking of any fiber show through from the thermoset resin.

A further alternative is to place the film in a frame or over a mold cavity as above, deposit thermoplastic resin over the film and mold the film-resin combination as above. After a short cooling period, the core is backed out by a predetermined distance (set by a small and predetermined excess of the final part thickness) and the thermoset resin desirably containing fibers is pumped or injected through the core into the open space. The core is reclosed after the desired amount of thermoset resin is injected to mold the thermoset resin to the initially molded part at the desired final part thickness. The core may here be heated to a temperature required to cure the resin, or a feed portion of the core may be heated to initiate the reaction, as in other embodiments. Desirably, the thermoset polyester resin is preheated to achieve a flowable viscosity but below the cure temperature of the peroxide catalyst. Alternatively, the core can be retracted an amount sufficient to supply a BMC or SMC charge in sheet form by a supply means between the core and shell in the cavity and the core sufficiently heated to cure the charge.

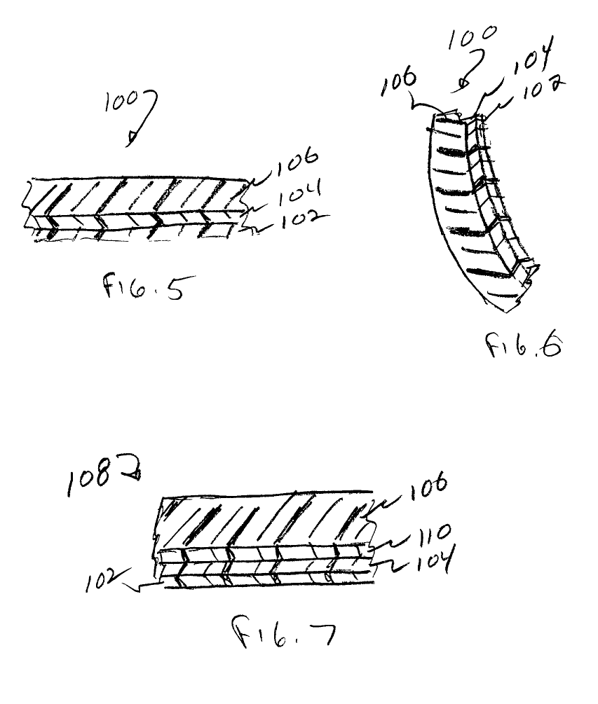

FIG. 5 shows a composite 100 of the present invention with outer film layer 102, thermoplastic layer 104 bonded to the outer film layer, and fiberglass reinforced thermoset layer 106 directly bonded to the thermoplastic layer by means of styrene in both the thermoset and thermoplastic layers. FIG. 6 shows the composite 100 of FIG. 4 in a representative compression molded and formed condition. FIG. 7 shows a further embodiment showing a composite 108 of the present invention with a veil or mat 110 between the thermoset layer 106 and thermoplastic layer 104 as a bonding or adhesion site.

While the foregoing procedure is aimed primarily at application in the exterior of vehicles, it should be noted that there are many other types of components that would benefit from the subject process of compression molding with a colored finish and with an accurately molded article, particularly for large household appliances and architectural components.

It is to be understood that the invention is not limited to the illustrations described and shown herein, which are deemed to be merely illustrative of the best modes of carrying out the invention, and which are susceptible of modification of form, size, arrangement of parts and details of operation. The invention rather is intended to encompass all such modifications which are within its spirit and scope as defined by the claims.

What is claimed is:

1. A composite material which comprises: an outer film layer; a thermoplastic layer bonded to the outer film layer; and a thermoset layer bonded to the thermoplastic layer; wherein the thermoset layer is bonded to the thermoplastic layer by an adhesion site that serves to bond the thermoplastic layer to the thermoset layer.

2. A composite material according to claim 1, wherein said adhesion site includes components in the thermoplastic layer and the thermoset layer that bond directly to each other.

3. A composite material according to claim 2, wherein said adhesion site results from the action of a chemically active component of the uncured thermoset material wherein the active component is the same as a monomer unit in the thermoplastic material.

4. A composite material according to claim 3, wherein said chemically active component of the uncured thermoset material is styrene.

5. A composite material according to claim 2, wherein the adhesion site results from the action of a chemically active component of the uncured thermoset material, wherein the active component is different from the monomer units in the thermoplastic material.

6. A composite according to claim 2, wherein the adhesion site results from the action of a reactive component in the thermoset layer, and the component in the thermoplastic layer is a monomer unit or polymer segment that is activated by the reactive component in the thermoset layer.

7. A composite according to claim 6, wherein the reactive component in the thermoset layer is selected from the group consisting of isocyanate, polyol, and epoxy, and the component in the thermoplastic layer is selected from the group consisting of styrene, acrylic, polycarbonate and polyester.

8. A composite material according to claim 1, wherein said adhesion site is a porous veil between the thermoplastic layer and thermoset layer, and wherein both said thermoplastic and thermoset layers impregnate and bond to said porous veil.

9. A composite material according to claim 8, wherein said porous veil is a non-woven, porous fabric with passageways therein.

10. A composite material according to claim 1, wherein said thermoset layer is fiberglass reinforced.

11. A composite material according to claim 1, wherein said outer film layer is a colored film.

12. A composite material according to claim 11, wherein said outer film layer is a colored film laminate.

13. A composite material according to claim 1, wherein said composite material is compression molded.

14. A composite material according to claim 1, wherein said thermoplastic layer has a thickness of from about 0.035 inch to about 0.120 inch.

15. A composite material according to claim 14, wherein said thermoset layer has a thickness of from about 0.035 inch to about 0.120 inch.

16. A composite material according to claim 14, wherein said outer film layer is less than about 0.030 inch.

17. A process for forming a composite material which comprises: sequentially depositing a thermoplastic layer onto an outer film layer, followed by depositing a thermoset layer onto the thermoplastic layer, wherein the thermoset layer is bonded to the thermoplastic layer by an adhesion site that serves to bond the thermoplastic layer to the thermoset layer.

18. A process according to claim 17, including providing that the adhesion site includes components in the thermoplastic layer and in the thermoset layer that bond directly to each other.

19. A process according to claim 18, including the step of providing that the adhesion site results from the action of a chemically active component of the uncured thermoset material, wherein the active component is the same as a monomer unit in the thermoplastic material.

20. A process according to claim 19, wherein said chemically active component of the uncured thermoset material is styrene.

21. A process according to claim 18, including the step of providing that the adhesion site results from the action of a chemically active component of the uncured thermoset material, wherein the active component is different from the monomer units in the thermoplastic material.

22. A process according to claim 18, including the step of providing that the adhesion site results from the action of a reactive component in the thermoset layer, and the component in the thermoplastic layer is a monomer unit or polymer segment that is activated by the reactive component in the thermoset layer.

23. A process according to claim 17, including the step of providing a porous veil as an adhesion site between the thermoplastic layer and the thermoset layer, wherein both said thermoplastic and thermoset layers impregnate and bond to said porous veil.

24. A process according to claim 17, including the step of providing said outer film layer as a colored film.

25. A process according to claim 24, including the step of providing that said outer film layer is a colored film laminate.

26. A process according to claim 17, including the step of compression molding said composite material.

27. A process according to claim 17, including the step of providing said thermoplastic layer in a thickness of from about 0.035 inch to 0.120 inch, and providing said thermoset layer in a thickness of from about 0.035 inch to about 0.120 inch.

28. A process according to claim 27, including the step of providing said outer film layer in a thickness less than about 0.030 inch.
